(19) United States
(12) Patent Application Publication
(10) Pub. No.: US 2023/0327821 A1
(43) Pub. Date: Oct. 12, 2023

(54) HARMONIZATION OF MULTIPLE CONFIGURED GRANT UPLINK WITH OR WITHOUT RETRANSMISSION TIMER

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Ozcan OZTURK, San Diego, CA (US)

(21) Appl. No.: 18/022,967

(22) PCT Filed: Oct. 12, 2020
(86) PCT No.: PCT/CN2020/120334

§ 371 Date: Feb. 23, 2023

(51) Int. Cl. H04L 1/1867; H04L 1/1812; H04L 5/00

(52) U.S. Cl. CPC H04L 1/1887; H04L 1/188; H04L 1/1896; H04L 1/1812; H04L 5/0055

(57) ABSTRACT

Dynamic grants (DG) for retransmission by a user equipment (UE) use the communication resource more efficiently while configured grants (CG) for retransmission by the UE reduce overhead and latency. A base station (BS) uses radio resource control signaling to configure the UE with a retransmission timer or without a retransmission timer. The BS transmits to the UE a set of CG configurations configuring a set of configured grant uplink (CG-UL) processes. The set of CG configurations includes information indicating whether or not a cg-RetransmissionTimer is associated with the CG-UL processes. The BS is also configured to receive communication on UL from the UE. The communication from the UE is received based on the set of CG-UL processes and the indication whether or not a cg-RetransmissionTimer is associated with the CG-UL processes. A UE may have different channel conditions for a plurality of CG-UL processes of the UE and therefore using a combination of CG based retransmission and DG based retransmission will reduce latency and reduce overhead and use the resource more efficiently.

### BACKGROUND

### Technical Field

The present disclosure relates generally to communication systems, and more particularly, dynamic switching between retransmission of data based on a retransmission timer or an uplink grant.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Dynamically scheduled retransmission of data (dynamic grant or DG) is based on an indication from the base station (BS) of an uplink (UL) grant. Non-dynamically scheduled retransmission of data (configured grant or CG) is based on the configured parameter cg-RetransmissionTimer. Dynamic grants for retransmission use the communication resource more efficiently while configured grants for retransmission reduce overhead and latency.

In wireless communication, a BS uses radio resource control (RRC) signaling to configure the user equipment (UE). The UE can be configured with a retransmission timer or without a retransmission timer.

In an aspect of the disclosure, a method, a computer-readable medium, and an apparatus are provided. A BS apparatus is configured to transmit to a UE a set of CG configurations configuring a set of configured grant uplink (CG-UL) processes. The set of CG configurations includes information indicating whether a cg-RetransmissionTimer is associated with the CG-UL processes. The BS apparatus is also configured to receive communication on UL from the UE. The communication from the UE is received based on the set of CG-UL processes and the indication whether a cg-RetransmissionTimer is associated with the CG-UL processes.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a diagram illustrating an example communication between a UE and a BS using a cg-retransmission timer.

FIG. 5 is a diagram illustrating an example communication between a UE and a BS using an UL grant.

FIG. 6 is a diagram illustrating an example communication between a UE and a BS switching from an UL grant to a cg-retransmission timer.

FIG. 7 is a flowchart of a method of wireless communication.

FIG. 8 is a flowchart of a method of wireless communication.

FIG. 9 is a diagram illustrating an example of a hardware implementation for an example UE apparatus.

FIG. 10 is a diagram illustrating an example of a hardware implementation for an example BS apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

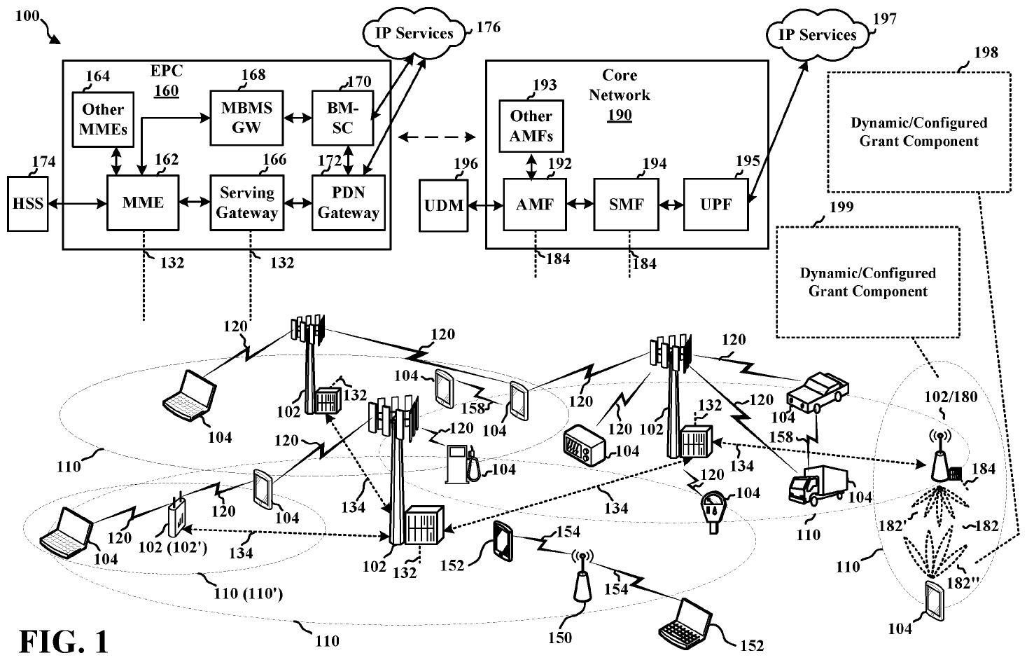

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured with a dynamic/configured grant component (198) to allow the UE 104 to retransmit based on an UL grant or a cg-RetransmissionTimer. In certain aspects, the base station 180 may be configured with a dynamic/configured grant component (199) to allow the BS 180 to configure or reconfigure the UE 104 to retransmit based on an UL grant or a cg-RetransmissionTimer. Although the following description may be focused on 5G NR, the concepts described herein may be applicable to other similar areas, such as LTE, LTE-A, CDMA, GSM, and other wireless technologies.

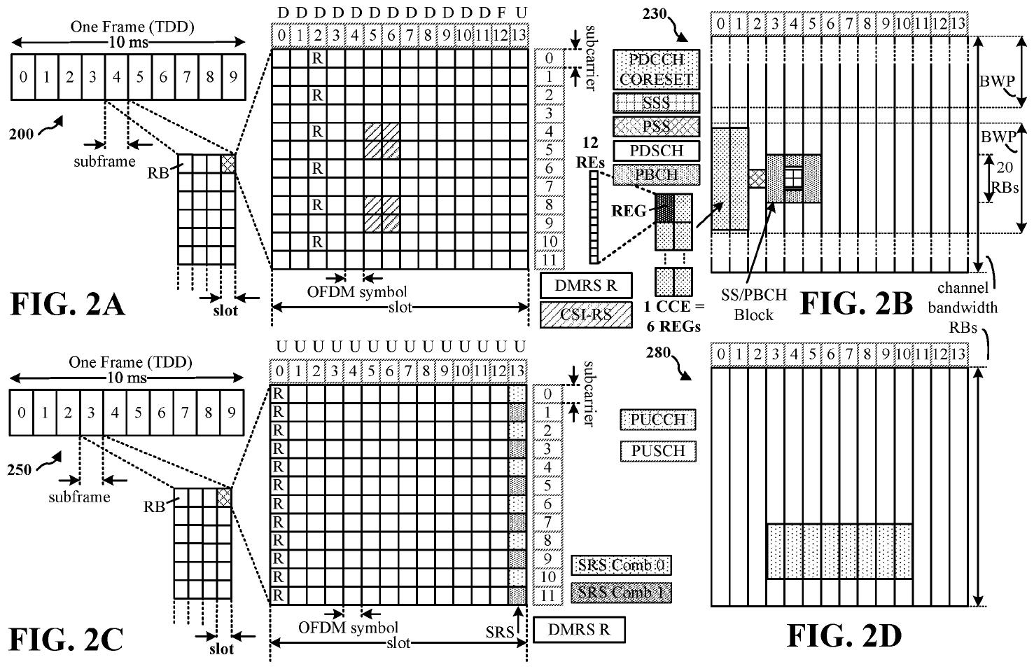

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame.

The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

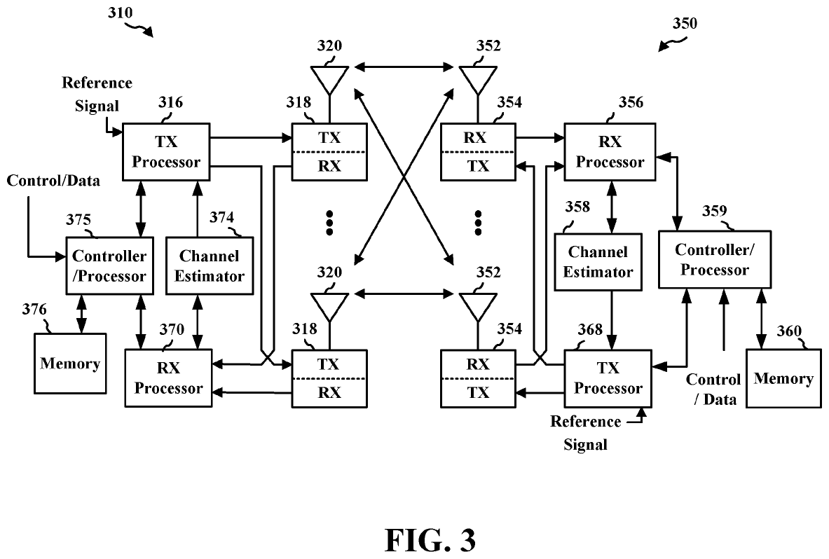

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

In wireless communication, UL data transmission can be configured by the BS without a UL grant, for example using semi-static configuration or optional DCI activation. Configured grant UL can be configured using a CG configuration. Some parameters related to a HARQ process for a Type 1 (RRC Based) configuration where configuration is handled through RRC include: configured scheduling (CS)—radio network temporary identifier (RNTI)(cs-RNTI) for retransmission; periodicity for identifying a periodicity of the configured grant; timeDomainOffset for an offset of a resource with respect to SFN=0 in the time domain; timeDomainAllocation for a configured uplink grant in the time domain which contains startSymbolAndLength (SLIV); and nrofHARQ-Processes for identifying the number of HARQ processes for the configured grant.

Some parameters related to a HARQ process for a Type 2 (DCI Activation/Deactivation) configuration where configuration is handled via RRC include: configured scheduling (CS)—radio network temporary identifier (RNTI)(cs-RNTI) for activation, deactivation, and retransmission; periodicity for identifying a periodicity of the CG; nrofHARQ-Processes for identifying the number of HARQ processes for the configured grant; where L1 signaling indicates additional parameters for the resource include an offset associated with the periodicity; and where MAC CE is use as an ACK for L1 signaling for activation/deactivation.

In one aspect for time domain resource allocation (TDRA), a number of allocated slots are added starting from the slot offset and using the slot period. Also, a number of consecutive PUSCH are added in a slot, where the length of each PUSCH is the same. The time domain resource assignment in the configured grant repeats over the multiple added slots within the CG-allocated slots. The same symbol allocation and mapping type is used for the first PUSCH in every slot of the allocated CG-slots. Additionally, the SLIV indicates information about the first PUSCH in a slot, then repeats with the same length.

In one aspect for CG-uplink control information (CG-UCI), CG-UCI is included in every CG-PUSCH transmission. For example, CG-UCI may include at least the following information: HARQ ID, network device interface (NDI), redundancy version (RV), and channel occupancy time (COT) sharing information.

In one aspect, two types of PUSCH repetitions are defined, where both types of PUSCH repetitions are applicable to dynamic grant retransmissions and configured grant retransmissions. PUSCH repetition Type A has no optimization unless the number of repetitions may be indicated dynamically. For example, if a number of repetition K>1, the same SLIV is applied across K consecutive slots. PUSCH repetition Type B provides for repetitions within/across slots, crossing the slot boundary, dynamic indication of the number of repetitions, inter-nominal PUSCH frequency hopping, new U/D symbol interaction, and new SLIV, just to name a few. For example, K nominal repetitions, each with nominal length L, are sent back-to back starting from symbol S, where S and L are given by SLIV.

In another aspect, when retransmission of CG-UL is based on the indication of UL grant, retransmission is considered a dynamic grant. When retransmission CG-UL processes is based on the CG (e.g., based on the parameter cg-RetransmissionTimer) retransmission is considered a configured grant. CG based retransmission can reduce the PDCCH overhead and thereby reduce transmission latency while DG based retransmission provides more efficient use of the resource. A UE may have different channel conditions for a plurality of CG-UL processes of the UE and therefore using a combination of CG based retransmission and DG based retransmission will reduce latency and reduce overhead and use the resource more efficiently.

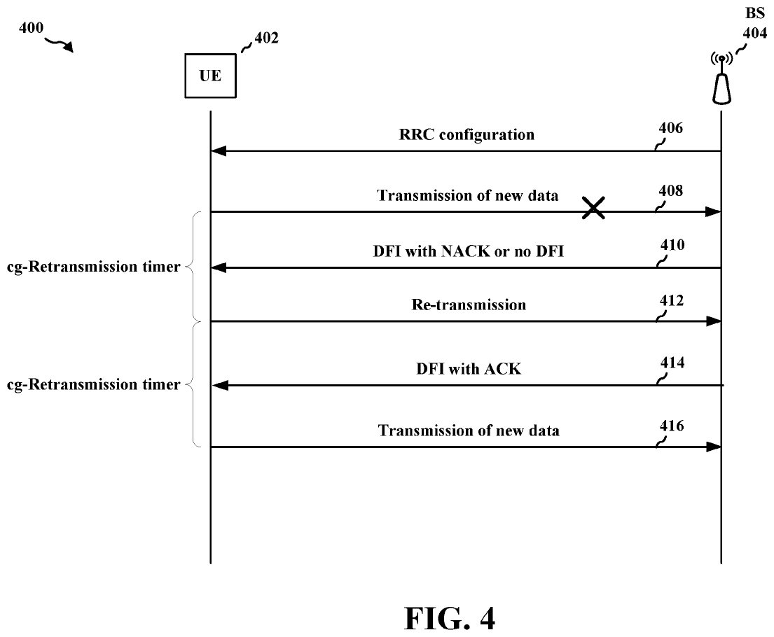

FIG. 4 is a diagram illustrating an example communication 400 between a UE 402 and a BS 404 using a cg-retransmission timer. In an unlicensed band, retransmission is typically implemented using a configured grant. At 406, the BS 404 configures the UE 402 with an RRC configuration. For example, the RRC configuration configure s retransmission to be based on the cg-RetransmissionTimer and CG-downlink feedback information (DFI)(CG-DFI). The cg-RetransmissionTimer parameter provides the duration after a configured grant transmission (or subsequent retransmission) of a HARQ process when the UE does not autonomously retransmit that HARQ process.

In an aspect, if DCI format 0_1 is used for indicating CG-DFI, the HARQ-ACK bitmap field is set to 16 bits, where the order of the bitmap to HARQ process index mapping is such that the HARQ process indices are mapped in ascending order from most significant bit (MSB) to the least significant bit (LSB) of the bitmap. For example, for each bit of the bitmap, value 1 indicates ACK, and value 0 indicate s NACK. Additionally, the TPC command for the scheduled PUSCH is allocated 2 bits and all the remaining bits in format 0_1 are set to zero. If DFI indicates that the transmission is NACK, or if DFI is not received by the UE during the time defined by cg-RetransmissionTimer, retransmission will occur. Otherwise, if DFI is received and indicates ACK, retransmission will not occur.

At 408, the UE 402 transmits new data to the BS 404. The transmission is the starting time for the cg-RetransmissionTimer. At 410, the BS 404 responds to the UE 402 transmission by sending DFI with a NACK or by not sending DFI. At 412, when an amount of time equal to the valud of the cg-RetransmissionTimer parameter has passed, the UE 402 retransmits the data to the BS 404. The retransmission at 412 starts a new retransmission time period. At 414, the BS 404 responds to the UE 402 by sending DFI with an ACK and at 416 the UE 402 transmits new data to the BS 404.

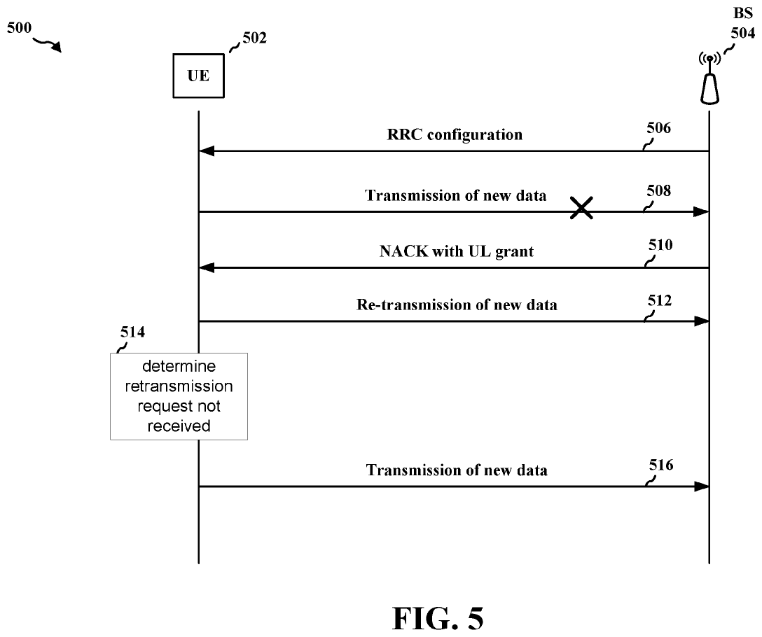

FIG. 5 is a diagram illustrating an example communication 500 between a UE 502 and a BS 504 using an UL grant. In a licensed band, retransmission is typically implemented using a dynamic grant. For example, if the BS 504 decodes a data transmission from the UE 502 as NACK, the BS 404 will send an uplink grant to the UE 502 and indicate that retransmission is required. Additionally, if the BS 504 misses the data transmission from the UE 502, the BS 504 will not send the uplink grant to the UE 502 and the UE 502 will not perform retransmission.

In one aspect, at 506 the BS 504 configures the UE 502 with an RRC configuration. At 508, the UE 502 transmits new data to the BS 504. At 510, the BS 504 responds to the UE 502 transmission by a NACK with an uplink grant. At 512, the UE 502 retransmits the data to the BS 504 as scheduled in the uplink grant. At 514, the UE determines if it has received a retransmission request from the BS. If the UE has not received a retransmission request (e.g., DCI 0_0/0_1 with NDI not toggled) after a time period, the UE 502 determines that the BS 504 successfully received and decoded the retransmission 512. After determining that the BS 504 successfully received and decoded the retransmission 512, at 516 the UE 502 transmits new data to the BS 504.

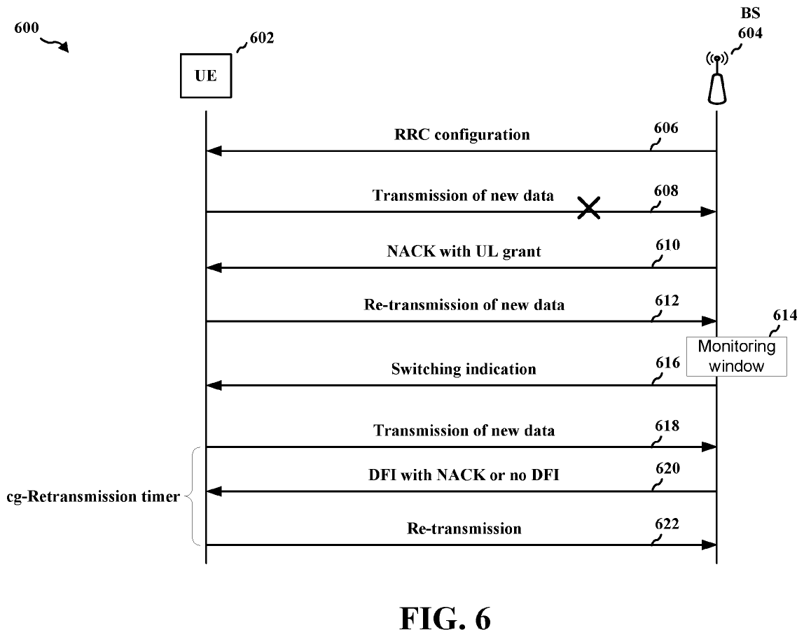

FIG. 6 is a diagram illustrating an example communication 600 between a UE 602 and a BS 604 switching from an UL grant to a cg-retransmission timer. In one aspect, for URLLC, retransmission of CG-UL is based on the indication of uplink grant and is thereby dynamically granted. In one aspect, retransmission of CG-UL is based on DFI and configured granted with the retransmission timer parameter cg-RetransmissionTimer. Advantageously, in wireless communication it is allowed for cg-RetransmissionTimer to be not configured for a CG-UL.

Accordingly, in one aspect when multiple CG-UL processes are configured, all of the cg-RetransmissionTimer configurations are configured the same. In other words, all of the configured CG-UL processes are configured with the cg-RetransmissionTimer or all of the configured CG-UL processes are configured without the cg-RetransmissionTimer.

In another aspect, each CG-UL process can be independently configured with a cg-RetransmissionTimer or without a cg-RetransmissionTimer. Moreover, for those CG-UL processes configured with a cg-RetransmissionTimer, the value of the cg-RetransmissionTimer time period parameter may vary.

For example, in the frequency domain, if there are multiple listen before talk (LBT) bandwidths, some CG-UL processes in some LBT bandwidths with low interference can be configured without cg-RetransmissionTimer. Additionally, other CG-UL processes in other LBT bandwidths with high interference can be configured with cg-RetransmissionTimer.

In one aspect, different logical channels may have different service patterns. For example, some logical channels may be used for URLLC while other logical channels may be used for eMBB. Accordingly, the CG-UL processes corresponding to URLCC channels can be configured without cg-RetransmissionTimer, and the CG-UL processes corresponding to eMBB channels can be configured with cg-RetransmissionTimer.

In one aspect, in the time domain, the channel condition may vary during the time period. Accordingly, the BS 604 is configured to dynamically switch the retransmission mode of CG-UL processes on the UE 602 to reduce PDCCH overhead and reduce transmission latency and to optimize efficient use the resource.

In one aspect, for CG-UL processes that are configured without cg-RetransmissionTimer, the different CG-UL processes are configured with different HARQ process ID sets to avoid overlap. Additionally, for CG-UL processes that are configured with cg-RetransmissionTimer, the UE 602 is configured to select a HARQ Process ID from among the HARQ process IDs made available for the configured grant configuration.

In a mixed configuration aspect, a first subset of CG-UL processes are configured with cg-RetransmissionTimer and a second subset of CG-UL processes are configured with cg-RetransmissionTimer. In this aspect, the HARQ process IDs for each CG-UL process must be determined.

In one aspect, the available HARQ process IDs can be arranged into a first set for the CG-UL processes configured without cg-RetransmissionTimer (set 1), and a second set for CG-UL processes configured with cg-RetransmissionTimer (set 2), and a third set for other scheduled grants. The first set of HARQ process IDs can be further arranged into subsets where the number of subsets is equal to the number of CG-UL processes. For the HARQ process IDs in the second set, the UE 602 is configured to select a HARQ process ID from the second set for each CG-UL process configured with cg-RetransmissionTimer.

In one aspect, DFI for CG-PUSCH includes HARQ information including HARQ-ACK information. Accordingly, in one aspect the HARQ-ACK information is included in DFI and indicates the number of bits for the HARQ-ACK bitmap. For example, the number of bits for the HARQ-ACK bitmap may be equal to the number of CG-UL processes with cg-RetransmissionTimer.

Turning back to FIG. 6, in one aspect, at 606 the BS 604 configures the UE 602 with an RRC configuration indicating no cg-RetransmissionTimer. At 608, the UE 602 transmits new data to the BS 604. At 610, the BS 604 responds to the UE 602 transmission by a NACK with an uplink grant. At 612, the UE 602 retransmits the data to the BS 604 as scheduled in the uplink grant.

At 614, the BS 604 monitors communications during a monitor time window having a predefined periodicity. Monitoring may include monitoring a number of transmitted UL grants for CG-UL retransmissions during the monitor time window. For example, the BS 604 may count the number of UL grants that are sent to the UE 602. The BS 604 may also monitor and/or count the number of DFI with ACK that are transmitted to the UE 602.

Monitoring may also include evaluating communication channel characteristics such a reference signal received quality (RSRQ), a reference signal received power (RSRP), a signal to noise ratio (SNR), a signal to interference plus noise ratio (SINR), or a bandwidth energy in association with receptions on UL from the UE.

At 616, the BS 604 transmits a switching indication to the UE 602 indicating that one or more of the CG-UL processes should switch to a configuration with cg-RetransmissionTimer, for example, when the number of UL grants exceeds a threshold.

At 618, the UE 602 transmits new data to the BS 604. The transmission is the starting time for the newly configured cg-RetransmissionTimer. At 620, the BS 604 responds to the UE 602 transmission by sending DFI with a NACK or by not sending DFI. At 622, when an amount of time equal to the value of the cg-RetransmissionTimer parameter has passed, the UE 602 retransmits the data to the BS 604. Additional retransmissions may or may not be required as wireless communication continue s between they UE 602 and the BS 604.

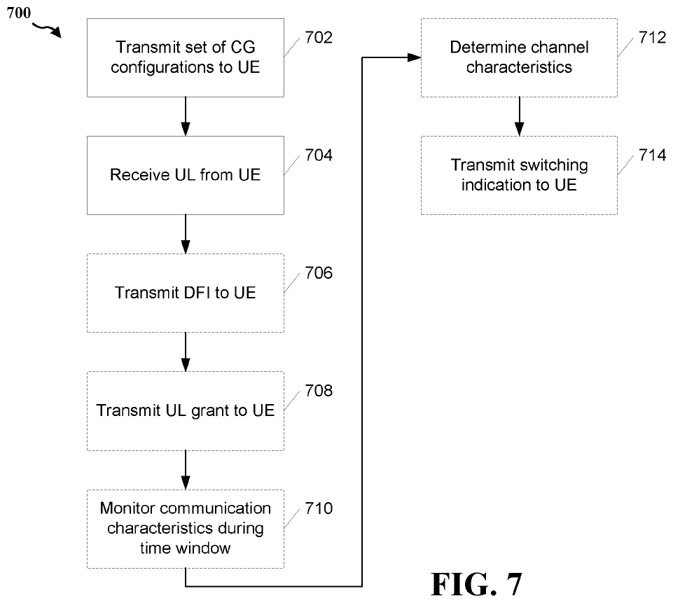

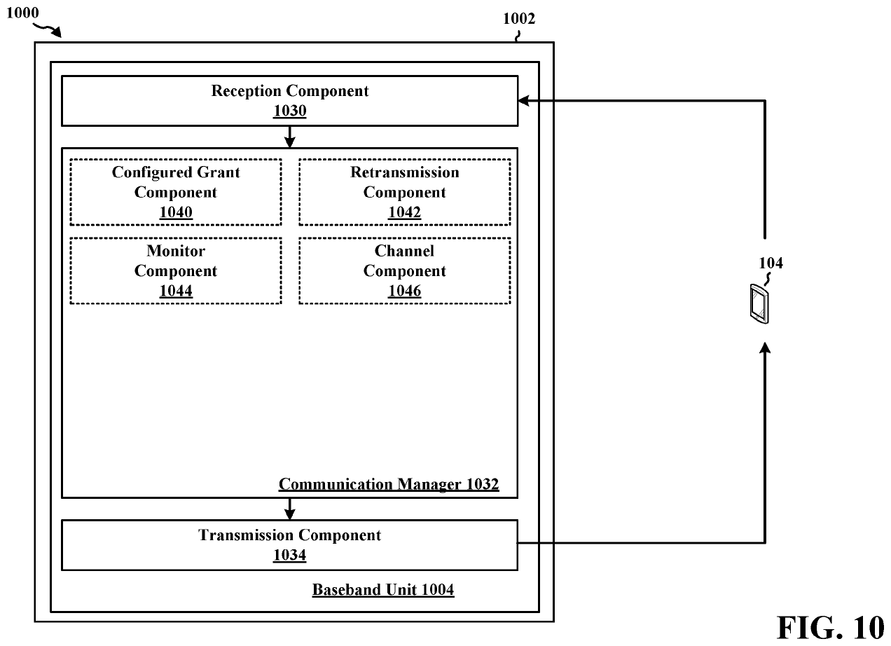

FIG. 7 is a flowchart 700 of a method of wireless communication. The method may be performed by a base station (e.g., the base station 102/180; the apparatus 1002. At 702, the base station is configured to transmit a set of configured grant configurations to the UE. The set of CG configurations configures a set of CG-UL processes and includes information indicating whether at least one cg-RetransmissionTimer is associated with the set of CG-UL processes. For example, 702 may be performed by the configured grant component 1040 from FIG. 10.

At 704, the BS receives a transmission on UL from the UE. The transmission on UL from the UE may be based on the set of CG-UL processes and the indication whether the at least one cg-RetransmissionTimer is associated with each of the set of CG-UL processes. For example, 704 may be performed by the retransmission component 1042 from FIG. 10.

In one aspect, the at least one cg-RetransmissionTimer comprises one cg-RetransmissionTimer, and the set of CG configurations includes information indicating whether the same cg-RetransmissionTimer is associated with the entire set of CG-UL processes.

In one aspect, each CG configuration of the set of CG configurations include s information indicating whether a cg-RetransmissionTimer is associated with a corresponding CG-UL process. Additionally, each CG configuration of the set of CG configurations may also include information indicating that the same cg-RetransmissionTimer is associated with the corresponding CG-UL process. Alternatively, each CG configuration of the set of CG configurations may include information indicating that no retransmission timer is associated with the corresponding CG-UL process. Alternatively, each CG configuration of the set of CG configurations may include information indicating that an independent cg-RetransmissionTimer is associated with each corresponding CG-UL process, or that no cg-RetransmissionTimer is associated with the corresponding CG-UL process. For example, each CG configuration in a first subset of the CG configurations may include information indicating that a first cg-RetransmissionTimer is associated with the corresponding CG-UL process and also indicating that each CG configuration in a second subset of the CG configurations includes information indicating no cg-RetransmissionTimer is associated with the corresponding CG-UL process.

In one aspect, the transmission received from the UL is associated with the first subset of the CG configurations when the transmission received from the UL is associated with eMBB communication. In an alternative aspect, the transmission received from the UL is associated with the second subset of the CG configurations when the transmission received from the UL is associated with URLLC.

At 706, the BS may optionally transmit DFI to the UE. In one aspect, 706 may be performed by the retransmission component 1042 from FIG. 10. For example, when the first subset of CG configurations is associated with a first subset of CG-UL processes and also associated with a first set of HARQ process identifiers, and the second subset of CG configurations is associated with a second subset of CG-UL processes and also associated with a second set of HARQ process identifiers, the BS may optionally transmit DFI including HARQ-ACK information for the first subset of CG-UL processes based on the first set of HARQ process IDs.

In one aspect, one CG-UL process of the second subset of CG-UL processes is associated with one HARQ process identifier of the second set of HARQ process identifiers. Additionally, the HARQ-ACK information for the first subset of CG-UL processes may include a HARQ-ACK bitmap including one bit per CG-UL process in the first subset of CG-UL processes.

In one aspect, when the set of CG configurations includes a first CG configuration indicating a first cg-RetransmissionTimer is associated with a first CG-UL process, the BS transmits DFI including an ACK or a NACK based on the received UL from the UE

At 708, the BS may optionally transmit an UL grant to the UE. In one aspect, 708 may be performed by the retransmission component 1042 from FIG. 10. The BS may transmit an UL grant to the UE when an expected transmission was not received from the UE or when a received transmission was unable to be decoded. For example, when the first subset of CG configurations is associated with a first subset of CG-UL processes and also associated with a first set of HARQ process identifiers, and the second subset of CG configurations is associated with a second subset of CG-UL processes and also associated with a second set of HARQ process identifiers, the BS may transmit UL grants for the second subset of CG-UL processes based on the second set of HARQ process IDs and based on the reception in UL from the UE. The UE may also transmit an UL grant to the UE for a CG-UL retransmission for the first CG-UL process when the reception on the UL from the UE is undecodable.

At 710, the BS may optionally monitor communication characteristics during a time window. The time window may have a periodicity. In one aspect, 710 may be performed by the monitor component 1044 from FIG. 10. In one aspect, when the UE is configured with cg-RetransmissionTimer, the BS monitors for a number of transmitted ACKs during the time window. In another aspect, when the UE is configured without cg-RetransmissionTimer, the BS monitors for a number of transmitted UL grants for CG-UL retransmissions during the time window.

At 712, the BS may optionally determine communication channel characteristics. In one aspect, 712 may be performed by the channel component 1046 from FIG. 10. For example, when the UE is configured with cg-RetransmissionTimer, the BS may determine at least one of a reference signal received quality (RSRQ), a reference signal received power (RSRP), a signal to noise ratio (SNR), a signal to interference plus noise ratio (SINR), or a bandwidth energy in association with receptions on UL from the UE. Additionally, when the UE is configured without cg-RetransmissionTimer, the BS may also determine at least one of a reference signal received quality (RSRQ), a reference signal received power (RSRP), a signal to noise ratio (SNR), a signal to interference plus noise ratio (SINR), or a bandwidth energy in association with receptions on UL from the UE.

At 714, the BS may optionally transmit a switching indication to the UE. In one aspect, 714 may be performed by the retransmission component 1042 from FIG. 10.

For example, when the UE is configured with cg-RetransmissionTimer, the BS may transmit a switching indication to the UE indicating that the first CG-UL process should be unassociated with a cg-RetransmissionTimer when the number of transmitted ACKs is greater than a threshold. The BS may also transmit a switching indication to the UE indicating that the first CG-UL process should be unassociated with a cg-RetransmissionTimer when the at least one of the RSRQ, RSRP, SNR, or SINR is greater than a first threshold, or the determined bandwidth energy is less than a second threshold.

Additionally, when the UE is configured without cg-RetransmissionTimer, the BS may transmit a switching indication to the UE indicating that the first CG-UL process should be associated with a first cg-RetransmissionTimer when the number of transmitted UL grants for CG-UL retransmissions is greater than a threshold. The BS may also transmit a switching indication to the UE indicating that the first CG-UL process should be associated with a first cg-RetransmissionTimer when the at least one of the RSRQ, RSRP, SNR, or SINR is less than a first threshold, or the determined bandwidth energy is greater than a second threshold.

In one aspect, when some CG-UL processes are configured with cg-RetransmissionTimer and some CG-UL processes are configured without cg-RetransmissionTimer, the BS may transmit a switching indication to the UE to switch a first CG-UL process configured with cg-RetransmissionTimer to be configured without cg-RetransmissionTimer and may also transmit a switching indication to the UE to switch a second CG-UL process configured without cg-RetransmissionTimer to be configured with cg-RetransmissionTimer.

In one aspect, the switching indication may be transmitted through at least one bit in a physical downlink control channel (PDCCH). In another aspect, the switching indication may be transmitted through at least one bit in a group common (GC) physical downlink control channel (PDCCH), the GC-PDCCH providing the switching indication to a set of UEs.

In one aspect, the GC-PDCCH may be transmitted in downlink control information (DCI). For example, the GC-PDCCH may be transmitted in a DCI format 2_0, 2_1, 2_2, 2_3, 2_4, 2_5, or 2_6 message. Alternatively, the GC-PDCCH may be transmitted in a DCI format 2_x message, where x>6.

In one aspect, the switching indication may be transmitted through at least one bit in a media access control (MAC) control element (CE) (MAC-CE). Additionally, the switching indication may be transmitted through at least two bits in a MAC-CE to indicate multiple CG-UL configurations. In one aspect, the total amount of the at least two bits is equal to the number of CG configurations in the set of CG configuration.

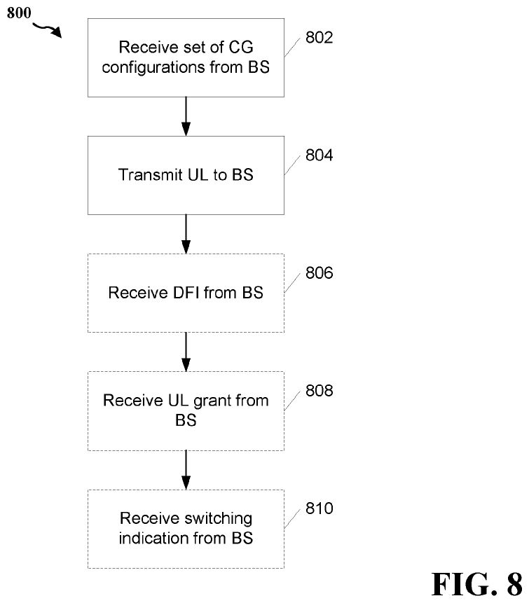

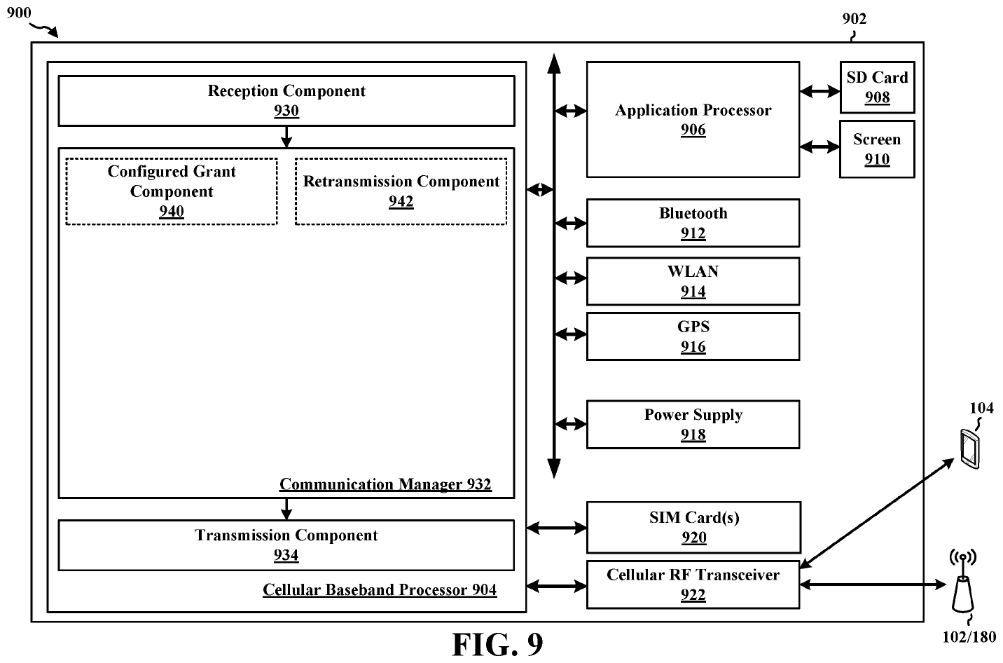

FIG. 8 is a flowchart 800 of a method of wireless communication. The method may be performed by a UE (e.g., the UE 104; the apparatus 902). At 802, the UE receives a set of CG configurations from the BS. In one aspect, 802 may be performed by the configured grant component 940 of FIG. 9. For example, the UE may receive, from the BS, a set of CG configurations configuring a set of CG-UL processes. The set of CG configurations may include information indicating whether at least one cg-RetransmissionTimer is associated with the set of CG-UL processes.

At 804, the UE transmits on UL to the BS. For example, 804 may be performed by the retransmission component 942 of FIG. 9. In one aspect, the UE may transmit on UL to the BS based on the set of CG-UL processes and the indication whether the at least one cg-RetransmissionTimer is associated with each of the set of CG-UL processes. For example, the at least one cg-RetransmissionTimer may include one cg-RetransmissionTimer, and the set of CG configurations may include information indicating whether a same one cg-RetransmissionTimer is associated with the set of CG-UL processes.

In one aspect, each CG configuration of the set of CG configurations includes information indicating whether a cg-RetransmissionTimer is associated with a corresponding CG-UL process. For example, all CG-UL processes may be associated with the same cg-RetransmissionTimer, or all CG-UL processes may be associated with no cg-RetransmissionTimer, or there may be a mix of some CG-UL processes associated with the same cg-RetransmissionTimer and some CG-UL processes associated with no cg-RetransmissionTimer. In one aspect, among those CG-UL processes associated with a cg-RetransmissionTimer some may be associated with a first cg-RetransmissionTimer and some may be associated with a second cg-RetransmissionTimer.

In one aspect, each CG configuration of the set of CG configurations includes information indicating an independent cg-RetransmissionTimer is associated with the corresponding CG-UL process, or that no cg-RetransmissionTimer is associated with the corresponding CG-UL process. In a further aspect, each CG configuration in a first subset of the CG configurations may include information indicating a first cg-RetransmissionTimer is associated with the corresponding CG-UL process, and each CG configuration in a second subset of the CG configurations may include information indicating no cg-RetransmissionTimer is associated with the corresponding CG-UL process.

For example, each CG configuration in the first subset of the CG configurations may include information indicating an enhanced mobile broadband (eMBB) channel is associated with the corresponding CG-UL process. Alternatively, each CG configuration in the second subset of the CG configurations may include information indicating an ultra-reliable low-latency communication (URLLC) channel is associated with the corresponding CG-UL process.

At 806, the UE optionally receives DFI from the BS. For example, 806 may be performed by the retransmission component 942 of FIG. 9. In one aspect, where the first subset of CG configurations is associated with a first subset of CG-UL processes and also associated with a first set of HARQ process identifiers, and where the second subset of CG configurations is associated with a second subset of CG-UL processes and also associated with a second set of HARQ process identifiers, the UE may also receive DFI including HARQ-ACK information for the first subset of CG-UL processes based on the first set of HARQ process IDs.

For example, one CG-UL process of the second subset of CG-UL processes may be associated with one HARQ process identifier of the second set of HARQ process identifiers. Additionally, the HARQ-ACK information for the first subset of CG-UL processes may include a HARQ-ACK bitmap including one bit per CG-UL process in the first subset of CG-UL processes.

At 808, the UE optionally receives an UL grant from the BS. For example, 808 may be performed by the retransmission component 942 of FIG. 9. In one aspect, where the first subset of CG configurations is associated with a first subset of CG-UL processes and also associated with a first set of HARQ process identifiers, and where the second subset of CG configurations is associated with a second subset of CG-UL processes and also associated with a second set of HARQ process identifiers, the UE may also receive UL grants for the second subset of CG-UL processes based on the second set of HARQ process IDs and based on the transmission in UL to the BS.

For example, the set of CG configurations may include a first CG configuration indicating a cg-RetransmissionTimer is unassociated with a first CG-UL process and the UE may receive an UL grant from the BS for a CG-UL retransmission for the first CG-UL process when transmission on the UL to the BS is undecodable.

At 810, the UE optionally receives a switching indication from the BS. For example, 810 may be performed by the retransmission component 942 of FIG. 9. For example, when the UE is configured with cg-RetransmissionTimer, the UE may receive a switching indication indicating that the first CG-UL process should be unassociated with a cg-RetransmissionTimer when the number of ACKs transmitted by the BS is greater than a threshold. The UE may also receive a switching indication indicating that the first CG-UL process should be unassociated with a cg-RetransmissionTimer when at least one of the RSRQ, RSRP, SNR, or SINR is greater than a first threshold, or the determined bandwidth energy is less than a second threshold.

Additionally, when the UE is configured without cg-RetransmissionTimer, the UE may receive a switching indication indicating that the first CG-UL process should be associated with a first cg-RetransmissionTimer when the number of UL grants transmitted by the BS for CG-UL retransmissions is greater than a threshold. The UE may also receive a switching indication indicating that the first CG-UL process should be associated with a first cg-RetransmissionTimer when at least one of the RSRQ, RSRP, SNR, or SINR is less than a first threshold, or the determined bandwidth energy is greater than a second threshold.

In one aspect, when some CG-UL processes of the UE are configured with cg-RetransmissionTimer and some CG-UL processes of the UE are configured without cg-RetransmissionTimer, the UE may receive a switching indication to switch a first CG-UL process configured with cg-RetransmissionTimer to be configured without cg-RetransmissionTimer and may also receive a switching indication to switch a second CG-UL process configured without cg-RetransmissionTimer to be configured with cg-RetransmissionTimer.

In one aspect, the switching indication may be received through at least one bit in a physical downlink control channel (PDCCH). In another aspect, the switching indication may be received through at least one bit in a group common (GC) physical downlink control channel (PDCCH), where the GC-PDCCH providing the switching indication to a set of UEs.

In one aspect, the GC-PDCCH may be received in downlink control information (DCI). For example, the GC-PDCCH may be received in a DCI format 2_0, 2_1, 2_2, 2_3, 2_4, 2_5, or 2_6 message. Alternatively, the GC-PDCCH may be received in a DCI format 2_x message, where x>6.

In one aspect, the switching indication may be received through at least one bit in a MAC-CE. Additionally, the switching indication may be received through at least two bits in a MAC-CE to indicate multiple CG-UL configurations. In one aspect, the total amount of the at least two bits is equal to the number of CG configurations in the set of CG configurations.

FIG. 9 is a diagram 900 illustrating an example of a hardware implementation for an apparatus 902. The apparatus 902 is a UE and includes a cellular baseband processor 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The cellular baseband processor 904 communicates through the cellular RF transceiver 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 350 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see 350 of FIG. 3) and include the aforediscussed additional modules of the apparatus 902.

The communication manager 932 includes a configured grant component 940 that is configured to receive a configured grant configuration from the BS, e.g., as described in connection with 802 of FIG. 8. The communication manager 932 further includes a retransmission component 942 that is configured to communicate with the BS based on retransmission timers and uplink grants and to switch between retransmission timer and uplink grant based on an indication from the BS, e.g., as described in connection with 804, 806, 808 and 810 of FIG. 8.

The apparatus may include additional components that perform each of the blocks of the algorithm in the aforementioned flowcharts of FIG. 8. As such, each block in the aforementioned flowcharts of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the cellular baseband processor 904, includes means for receiving, from a base station (BS), a set of configured grant (CG) configurations configuring a set of configured grant uplink (CG-UL) processes, the set of CG configurations including information indicating whether at least one cg-RetransmissionTimer is associated with the set of CG-UL processes and means for means for transmitting on UL to the BS based on the set of CG-UL processes and the indication whether the at least one cg-RetransmissionTimer is associated with each of the set of CG-UL processes. The aforementioned means may be one or more of the aforementioned components of the apparatus 902 configured to perform the functions recited by the aforementioned means. As described supra, the apparatus 902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 10 is a diagram 1000 illustrating an example of a hardware implementation for an apparatus 1002. The apparatus 1002 is a BS and includes a baseband unit 1004. The baseband unit 1004 may communicate through a cellular RF transceiver with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 310 and may include the memory 376 and/or at least one of the TX processor 316, the RX processor 370, and the controller/processor 375.

The communication manager 1032 includes a configured grant component 1040 that is configured to configure a UE for retransmission based on a retransmission timer or based on an uplink grant, e.g., as described in connection with 702 of FIG. 7. The communication manager 1032 further includes a retransmission component 1042 that is configured to communicate with the UE based on retransmission timers and uplink grants and indicate to the UE when to switch between retransmission timer and uplink grant, e.g., as described in connection with 704, 706, 708, and 714 of FIG. 7. The communication manager 1032 further includes a monitor component 1044 that is configured to monitor channel conditions and other communication characteristics to determine whether to switch between retransmission timer and uplink grant, e.g., as described in connection with 710 and 712 of FIG. 7.

The apparatus may include additional components that perform each of the blocks of the algorithm in the aforementioned flowcharts of FIG. 8. As such, each block in the aforementioned flowcharts of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes means for transmitting, to a user equipment (UE), a set of configured grant (CG) configurations configuring a set of configured grant uplink (CG-UL) processes, the set of CG configurations including information indicating whether at least one cg-RetransmissionTimer is associated with the set of CG-UL processes and means for receiving on UL from the UE based on the set of CG-UL processes and the indication whether the at least one cg-RetransmissionTimer is associated with each of the set of CG-UL processes. The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1-25. (canceled)

26. An apparatus for wireless communication at a user equipment (UE), comprising:
a memory; and
at least one processor coupled to the memory and configured to:
receive, from a base station (BS), a set of configured grant (CG) configurations configuring a set of configured grant uplink (CG-UL) processes, the set of CG configurations including information indicating whether at least one cg-RetransmissionTimer is associated with the set of CG-UL processes; and
transmit on UL to the BS based on the set of CG-UL processes and the indication whether the at least one cg-RetransmissionTimer is associated with each of the set of CG-UL processes.

27. (canceled)

28. The apparatus of claim 26, wherein each CG configuration of the set of CG configurations includes information indicating whether a cg-RetransmissionTimer is associated with a corresponding CG-UL process.

29. The apparatus of claim 26, wherein each CG configuration of the set of CG configurations includes information indicating a same cg-RetransmissionTimer is associated with a corresponding CG-UL process.

30. The apparatus of claim 26, wherein each CG configuration of the set of CG configurations includes information indicating no retransmission timer is associated with a corresponding CG-UL process.

31. The apparatus of claim 26, wherein each CG configuration of the set of CG configurations includes information indicating an independent cg-RetransmissionTimer is associated with a corresponding CG-UL process, or that no cg-RetransmissionTimer is associated with the corresponding CG-UL process.

32. The apparatus of claim 31, wherein each CG configuration in a first subset of the CG configurations includes information indicating a first cg-RetransmissionTimer is associated with the corresponding CG-UL process, and wherein each CG configuration in a second subset of the CG configurations includes information indicating no cg-RetransmissionTimer is associated with the corresponding CG-UL process.

33. (canceled)

34. (canceled)

35. The apparatus of claim 32, wherein the first subset of CG configurations is associated with a first subset of CG-UL processes of the set of CG-UL processes and with a first set of hybrid automatic repeat request (HARQ) process identifiers (IDs), and the second subset of CG configurations is associated a second subset of CG-UL processes of the set of CG-UL processes and with a second set of HARQ process identifiers, the at least one processor further configured to:
receive downlink feedback information (DFI) including HARQ acknowledgment (ACK) (HARQ-ACK) information for the first subset of CG-UL processes based on the first set of HARQ process IDs; and
receive UL grants for the second subset of CG-UL processes based on the second set of HARQ process IDs and based on the transmission on UL to the BS.

36. The apparatus of claim 35, wherein one CG-UL process of the second subset of CG-UL processes is associated with one HARQ process identifier of the second set of HARQ process identifiers.

37. The apparatus of claim 35, wherein the HARQ-ACK information for the first subset of CG-UL processes comprises a HARQ-ACK bitmap including one bit per CG-UL process in the first subset of CG-UL processes.

38. The apparatus of claim 26, wherein the set of CG configurations includes a first CG configuration indicating a first cg-RetransmissionTimer is associated with a first CG-UL process, the at least one processor further configured to:
receive downlink feedback information (DFI) including one of an acknowledgment (ACK) or a negative ACK (NACK) based on the transmitted UL to the BS; and
receive, when a number of received ACKs is greater than a threshold, a switching indication from the BS indicating that the first CG-UL process should be unassociated with a cg-RetransmissionTimer.

39-42. (canceled)

43. The apparatus of claim 38, wherein to receive the switching indication, the at least one processor is configured to receive the switching indication through at least one bit in a physical downlink control channel (PDCCH).

44. The apparatus of claim 38, wherein to receive the switching indication, the at least one processor is configured to receive the switching indication through at least one bit in a group common (GC) physical downlink control channel (PDCCH), the GC-PDCCH providing the switching indication to a set of UEs including the UE.

45-47. (canceled)

48. The apparatus of claim 38, wherein to receive the switching indication, the at least one processor is configured to receive the switching indication through at least one bit in a media access control (MAC) control element (CE) (MAC-CE).

49-58. (canceled)

59. An apparatus for wireless communication at a base station (BS), comprising:
a memory; and
at least one processor coupled to the memory and configured to:
transmit, to a user equipment (UE), a set of configured grant (CG) configurations configuring a set of configured grant uplink (CG-UL) processes, the set of CG configurations including information indicating whether at least one cg-RetransmissionTimer is associated with the set of CG-UL processes; and
receive on UL from the UE based on the set of CG-UL processes and the indication whether the at least one cg-RetransmissionTimer is associated with each of the set of CG-UL processes.

60. The apparatus of claim 59, wherein each CG configuration of the set of CG configurations includes information indicating whether a cg-RetransmissionTimer is associated with a corresponding CG-UL process.

61. The apparatus of claim 60, wherein each CG configuration of the set of CG configurations includes information indicating a same cg-RetransmissionTimer is associated with the corresponding CG-UL process.

62. The apparatus of claim 60, wherein each CG configuration of the set of CG configurations includes information indicating no retransmission timer is associated with the corresponding CG-UL process.

63. The apparatus of claim 60, wherein each CG configuration of the set of CG configurations includes information indicating an independent cg-RetransmissionTimer is associated with the corresponding CG-UL process, or that no cg-RetransmissionTimer is associated with the corresponding CG-UL process.

64. The apparatus of claim 63, wherein each CG configuration in a first subset of the CG configurations includes information indicating a first cg-RetransmissionTimer is associated with the corresponding CG-UL process, and wherein each CG configuration in a second subset of the CG configurations includes information indicating no cg-RetransmissionTimer is associated with the corresponding CG-UL process.

65. The apparatus of claim 64, wherein UL reception is associated with the first subset of the CG configurations when the UL reception is associated with enhanced mobile broadband (eMBB) communication.

66. The apparatus of claim 64, wherein UL reception is associated with the second subset of the CG configurations when the UL reception is associated with ultra-reliable low-latency communications (URLLC).

67. The apparatus of claim 64, wherein the first subset of CG configurations is associated with a first subset of CG-UL processes of the set of CG-UL processes and with a first set of hybrid automatic repeat request (HARQ) process identifiers (IDs), and the second subset of CG configurations is associated a second subset of CG-UL processes of the set of CG-UL processes and with a second set of HARQ process identifiers, the at least one processor further configured to:
transmit downlink feedback information (DFI) including HARQ acknowledgment (ACK) (HARQ-ACK) information for the first subset of CG-UL processes based on the first set of HARQ process IDs; and
transmit UL grants for the second subset of CG-UL processes based on the second set of HARQ process IDs and based on the reception on UL from the UE.

68. The apparatus of claim 67, wherein one CG-UL process of the second subset of CG-UL processes is associated with one HARQ process identifier of the second set of HARQ process identifiers.

69. The apparatus of claim 67, wherein the HARQ-ACK information for the first subset of CG-UL processes comprises a HARQ-ACK bitmap including one bit per CG-UL process in the first subset of CG-UL processes.

70. The apparatus of claim 59, wherein the set of CG configurations includes a first CG configuration indicating a first cg-RetransmissionTimer is associated with a first CG-UL process, the at least one processor further configured to:
transmit downlink feedback information (DFI) including one of an acknowledgment (ACK) or a negative ACK (HACK) based on the received UL from the UE;
monitor for a number of transmitted ACKs during a time window, the time window having a periodicity; and
transmit a switching indication to the UE indicating that the first CG-UL process should be unassociated with a cg-RetransmissionTimer when the number of transmitted ACKs is greater than a threshold.

71. The apparatus of claim 59, wherein the set of CG configurations includes a first CG configuration indicating a cg-RetransmissionTimer is unassociated with a first CG-UL process, the at least one processor further configured to:
transmit an UL grant to the UE for a CG-UL retransmission for the first CG-UL process when the reception on UL from the UE is undecodable;
monitor for a number of transmitted UL grants for CG-UL retransmissions during a time window, the time window having a periodicity; and
transmit a switching indication to the UE indicating that the first CG-UL process should be associated with a first cg-RetransmissionTimer when the number of transmitted UL grants for the CG-UL retransmissions is greater than a threshold.

72. The apparatus of claim 59, wherein the set of CG configurations includes a first CG configuration indicating a first cg-RetransmissionTimer is associated with a first CG-UL process, the at least one processor further configured to:
determine at least one of a reference signal received quality (RSRQ), a reference signal received power (RSRP), a signal to noise ratio (SNR), a signal to interference plus noise ratio (SINR), or a bandwidth energy in association with receptions on UL from the UE; and
transmit a switching indication to the UE indicating that the first CG-UL process should be unassociated with a cg-RetransmissionTimer when the at least one of the RSRQ, RSRP, SNR, or SINR is greater than a first threshold, or the determined bandwidth energy is less than a second threshold.

73. The apparatus of claim 59, wherein the set of CG configurations includes a first CG configuration indicating a cg-RetransmissionTimer is unassociated with a first CG-UL process, the at least one processor further configured to:
determine at least one of a reference signal received quality (RSRQ), a reference signal received power (RSRP), a signal to noise ratio (SNR), a signal to interference plus noise ratio (SINR), or a bandwidth energy in association with receptions on UL from the UE; and
transmit a switching indication to the UE indicating that the first CG-UL process should be associated with a first cg-RetransmissionTimer when the at least one of the RSRQ, RSRP, SNR, or SINR is less than a first threshold, or the determined bandwidth energy is greater than a second threshold.

74. The apparatus of claim 59, wherein the set of CG configurations includes a first CG configuration indicating whether a first cg-RetransmissionTimer is associated with a first CG-UL process or no cg-RetransmissionTimer is associated with a first CG-UL process, the at least one processor further configured to:
transmit a switching indication to the UE to switch the association of the first CG-UL process and the first cg-RetransmissionTimer, the switching indication indicating one of that the first CG-UL process should be associated with the first cg-RetransmissionTimer or that the first CG-UL process should be associated with no cg-RetransmissionTimer.

75. The apparatus of claim 74, wherein to transmit the switching indication, the at least one processor is configured to transmit the switching indication through at least one bit in a group common (GC) physical downlink control channel (PDCCH), the GC-PDCCH providing the switching indication to a set of UEs including the UE.

76. The apparatus of claim 75, wherein to transmit the GC-PDCCH, the at least one processor is configured to transmit the GC-PDCCH in a downlink control information (DCI) format 2_0, 2_1, 2_2, 2_3, 2_4, 2_5, 2_6, or 2_x message, where x>6.

77. The apparatus of claim 74, wherein to transmit the switching indication, the at least one processor is configured to transmit the switching indication through at least one bit in a media access control (MAC) control element (CE) (MAC-CE).

78. The apparatus of claim 74, wherein to transmit switching indication, the at least one processor is configured to transmit the switching indication through at least two bits in a media access control (MAC) control element (CE) (MAC-CE) to indicate multiple CG-UL configurations.

79. A method of wireless communication at a user equipment (UE), comprising:
receiving, from a base station (BS), a set of configured grant (CG) configurations configuring a set of configured grant uplink (CG-UL) processes, the set of CG configurations including information indicating whether at least one cg-RetransmissionTimer is associated with the set of CG-UL processes; and
transmitting on UL to the BS based on the set of CG-UL processes and the indication whether the at least one cg-RetransmissionTimer is associated with each of the set of CG-UL processes.

80. A method of wireless communication at a base station (BS), comprising:
transmitting, to a user equipment (UE), a set of configured grant (CG) configurations configuring a set of configured grant uplink (CG-UL) processes, the set of CG configurations including information indicating whether at least one cg-RetransmissionTimer is associated with the set of CG-UL processes; and
receiving on UL from the UE based on the set of CG-UL processes and the indication whether the at least one cg-RetransmissionTimer is associated with each of the set of CG-UL processes.
